(19) United States
(12) Patent Application Publication
(10) Pub. No.: US 2016/0294251 A1
(43) Pub. Date: Oct. 6, 2016

(54) ELECTRIC COMPRESSOR

(71) Applicant: KABUSHIKI KAISHA TOYOTA JIDOSHOKKI, Aichi-ken (JP)

(72) Inventors: Hiroshi FUKASAKU, Aichi-ken (JP); Hiroyuki GENNAMI, Aichi-ken (JP)

(73) Assignee: KABUSHIKI KAISHA TOYOTA JIDOSHOKKI, Aichi-ken (JP)

(21) Appl. No.: 15/082,889

(22) Filed: Mar. 28, 2016

(30) Foreign Application Priority Data
Mar. 31, 2015 (JP) 2015-071867

(51) Int. Cl. H02K 7/04; F04C 29/00; H02K 1/27; F04C 18/02

(52) U.S. Cl. CPC H02K 7/04; F04C 18/0215; F04C 29/0085; F04C 29/0057; H02K 1/276

(57) ABSTRACT

An electric compressor includes a compression mechanism having a movable member, an electric motor including a rotary shaft, a shaft support member and a housing. The rotary shaft includes a shaft body and an eccentric pin. The electric motor includes a stator including a stator core and a coil, and a rotor that includes a rotor core. The coil has a first coil end located between the stator core and the compression mechanism and a second coil end. The rotor core has a first hole portion, a plurality of second hole portions, and a plurality of third hole portions. The balance weights include a first balance weight and at least part of the first balance weight is inserted in the third hole portion. At least part of the shaft support member faces an inner periphery of the first coil end and the first balance weight.

### BACKGROUND OF THE INVENTION

The present invention relates to an electric compressor.

Japanese Patent Application Publication H07-158169 proposes an electric compressor having a structure in which a rotor of the electric motor and a frame that supports a rotary shaft are disposed in overlapping relation to each other in order to reduce the dimension of the electric compressor in direction in which the electric motor and an compression mechanism are arranged, or to reduce the dimension of the electric compressor in axial direction of the electric motor.

In an electric compressor in which a movable member of the compression mechanism is mounted on an eccentric pin that is disposed eccentric to the rotation axis of the rotary shaft, a balance weight is mounted on an end portion of a rotor core of the electric motor so as to offset the centrifugal force applied to the movable member while making an orbital movement.

For an electric compressor mounted on a vehicle, a relatively large compression mechanism is used due to its high output requirement, which needs to increase the weight of the balance weight so as to offset the centrifugal force of the movable member.

However, the use of a larger balance weight prevents the electric compressor from reducing its axial dimension. Specifically, the disposition of a large balance weight between the rotor core and the frame makes it difficult to arrange the rotor and the frame in overlapping relation, with the result that the reduction of the axial dimension of the electric compressor is made difficult.

The present invention, which has been made in light of the above problems, is directed to providing an electric compressor having a structure that may reduce the axial dimension of the electric compressor while allowing the centrifugal force of the movable member of the compressor to be offset properly.

### SUMMARY OF THE INVENTION

In accordance with an aspect of the present invention, there is provided an electric compressor including a compression mechanism that has a movable member and compresses fluid, an electric motor having a rotary shaft and driving the compression mechanism, a shaft support member that is disposed between the compression mechanism and the electric motor and rotatably supports the rotary shaft, and a housing accommodating therein the compression mechanism, the electric motor and the shaft support member. The rotary shaft includes a shaft body and an eccentric pin extending from one end of the shaft body at a position that is eccentric to a rotation axis of the shaft body, and the eccentric pin supports the movable member. The electric motor includes a stator that includes a stator core fixed to the housing and a coil that is wound around the stator core, and a hollow cylindrical rotor that is fixed on the shaft body of the rotary shaft. The coil has a first coil end and a second coil end that extend out from opposite ends of the stator core in a direction of the rotation axis of the shaft body. The first coil end is arranged between the stator core and the compression mechanism. The rotor includes a cylindrical rotor core, a plurality of magnets that are disposed inside the rotor core, and a plurality of balance weights that are made of a non-magnetic material having a greater specific gravity than a material forming the rotor core, and the balance weights are disposed in the rotor core. The rotor core includes a first hole portion through which the rotary shaft is inserted, a plurality of second hole portions in which the respective magnets are inserted, and a plurality of third hole portions in which the respective balance weights are inserted. The balance weights have a first balance weight that is disposed in the vicinity of the first coil end in a direction of a rotation axis of the rotor core. At least part of the first balance weight is inserted in one of the third hole portions. At least part of the shaft support member faces an inner periphery of the first coil end and the first balance weight.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a longitudinal cross-sectional view of an electric compressor according to a first embodiment of the present invention;

FIG. 2 is a plan view of a rotor of the electric compressor of FIG. 1 as viewed from inverter side of the compressor;

FIG. 3 is a longitudinal cross-sectional view of the rotor taken along line of the FIG. 2 and as viewed in the arrow direction;

FIG. 4 is a plan view of a first magnetic steel sheet of the rotor of FIG. 2;

FIG. 5 is a plan view of a second magnetic steel sheet of the rotor of FIG. 2;

FIG. 6 is a longitudinal cross-sectional view of a rotor of an electric compressor according to a second embodiment of the present invention.

### DETAILED DESCRIPTION OF THE EMBODIMENTS

The following will describe an electric compressor of an embodiment of the present invention with reference to the accompanying drawings. For the sake of the description, like or same parts or elements among different embodiments are designated by the same reference numerals and the description thereof will not be reiterated.

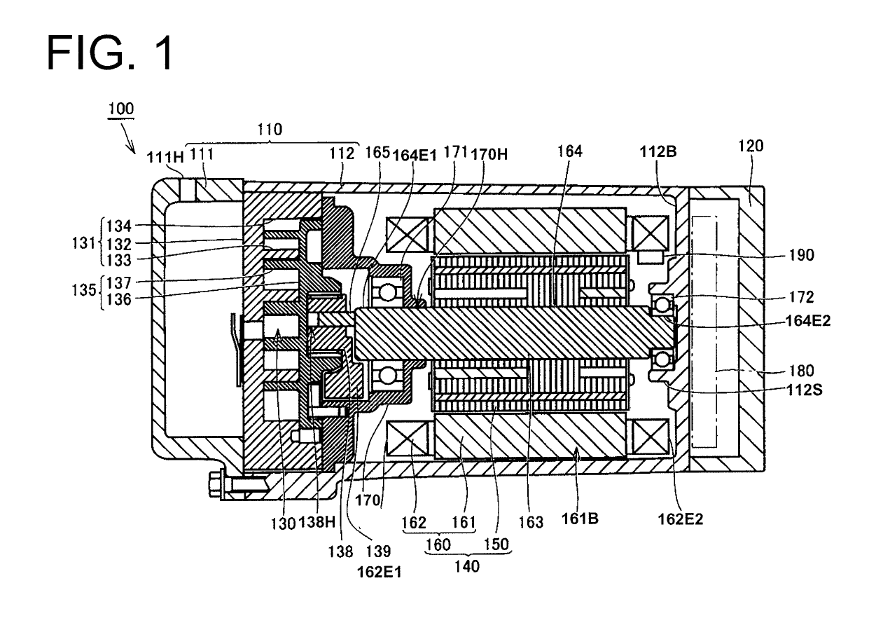

Referring to FIG. 1, there is shown an electric compressor 100 according to a first embodiment of the present invention. The electric compressor 100 includes a compression mechanism 130 that has a movable member and compresses a fluid, an electric motor 140 that has a rotary shaft 163 and drives the compression mechanism 130, an inverter 180 that drives the electric motor 140, and a shaft support member 170 that is disposed between the compression mechanism 130 and the electric motor 140 and rotatably supports the rotary shaft 163. The electric compressor 100 further includes a housing 110 that accommodates therein the compression mechanism 130, the electric motor 140 and the shaft support member 170 and a cover 120 that is mounted to the housing 110. The inverter 180 is arranged between the cover 120 and the housing 110. The compression mechanism 130, the shaft support member 170, the electric motor 140 and the inverter 180 are arranged in the electric compressor 100 in this order along axial direction of the rotary shaft 163.

The housing 110 includes a cylindrical suction housing 112 that is opened at one end and a bottomed cylindrical discharge housing 111 that is connected to the one end of the suction housing 112. The suction housing 112 is formed with a suction port (not shown) through which a refrigerant gas is drawn into the electric compressor 100 from an external refrigerant circuit (not shown). The discharge housing 111 is formed with a discharge port 111H. The suction housing 112 accommodates therein the compression mechanism 130, the shaft support member 170 and the electric motor 140. The housing 110 and the cover 120 cooperate to form the outer shell of the electric compressor 100.

The compression mechanism 130 compresses a refrigerant gas that is introduced through the suction port into the housing 110. In the present embodiment, the compression mechanism 130 includes a fixed scroll 131 and a movable scroll 135. The movable scroll 135 corresponds to the movable member of the present invention.

The fixed scroll 131 includes a disk shaped base plate 132, a spiral wall 133 extending perpendicularly from the base plate 132 and an outer peripheral wall 134 that extends perpendicularly from the outer peripheral edge of the base plate 132 so as to surround the spiral wall 133.

The movable scroll 135 includes a disk shaped base plate 136, a spiral wall 137 extending perpendicularly from the base plate 136 toward the base plate 132 of the fixed scroll 131. The fixed scroll 131 and the movable scroll 135 are disposed in facing relation to each other in axial direction of the rotary shaft 163.

The electric motor 140 is supplied with three phase electric power and drives to rotate the movable scroll 135, thus driving the compression mechanism 130. The electric motor 140 includes a stator core 161 that is fixed to the suction housing 112, a stator 160 that is formed by winding a three phase coil 162 on the stator core 161 and a hollow cylindrical rotor 150 that is disposed radially inward of the stator 160 and fixed on a shaft body 164 of the rotary shaft 163.

The rotary shaft 163 includes the shaft body 164 and an eccentric pin 165 extending from one end of the shaft body 164 of the rotary shaft 163 in axial direction thereof at a position that is eccentric to the rotation axis of the shaft body 164. The rotor 150 is fixed coaxially on the shaft body 164 of the rotary shaft 163.

A bush 138 having a weight 139 is fitted on the eccentric pin 165 of the rotary shaft 163. The weight 139 is configured to reduce the centrifugal force that is applied to the movable scroll 135 when the movable scroll 135 makes an orbital movement. The bush 138 has a hole 138H that is formed eccentric to the axis of the bush 138 and the eccentric pin 165 is fitted in the hole 138H. With the rotation of the rotary shaft 163, the bush 138 is rotated or swung about the eccentric pin 165.

The base plate 136 of the movable scroll 135 is supported by an eccentric pin bearing (not shown) so as to be rotatable relative to the bush 138. In other words, the movable scroll 135 is supported by the eccentric pin 165.

The axial center of the bush 138 is positioned closer to the outer periphery of the shaft body 164 of the rotary shaft 163 than the rotation axis of the shaft body 164. The base plate 136 of the movable scroll 135 and the bush 138 are coaxially aligned, so that the distance between the axial center of the bush 138 and the rotation axis of the shaft body 164 corresponds to the radius of orbital motion of the movable scroll 135.

The swinging movement of the bush 138 about the eccentric pin 165 changes the distance between the axis of the bush 138 and the rotation axis of the shaft body 164 thereby to change the rotational radius of the movable scroll 135. In other words, the eccentric pin 165, the bush 138 and the eccentric pin bearing cooperates to form a so-called driven crank mechanism that changes the rotational radius of the movable scroll 135.

The stator 160 includes a stator core 161 and a three phase coil 162 and is fixed to the suction housing 112. The stator core 161 includes a stator body 161B of a generally cylindrical shape and teeth (not shown). The stator core 161 is disposed coaxially with the shaft body 164 of the rotary shaft 163.

The three phase coil 162 is wound around the teeth of the stator core 161 and has first and second coil ends 162E1, 162E2 that extend out from the opposite ends of the stator body 161B of the stator core 161 in axial direction thereof (direction of rotation axis of the rotary body 164). The first coil end 162E1 is disposed in the vicinity of the compression mechanism 130 and the second coil end 162E2 is disposed in the vicinity of the inverter 180 that is provided on the opposite side from the compression mechanism 130. The first coil end 162E1 is located between the stator core 161 and the compression mechanism 130.

An electric power that has been controlled by the inverter 180 is supplied through a cluster block 190 to the three phase coil 162. The cluster block 190 is arranged radially inward of the stator 160. Specifically, the cluster block 190 of the present embodiment is disposed inward of the second coil end 162E2 in radial direction of the rotary shaft 163. In addition, the cluster block 190 is disposed so as to face the second coil end 162E2 in radial direction of the rotary shaft 163.

The shaft support member 170 having a cylindrical shape is fixed in the suction housing at a location that is in the vicinity of the opening of the suction housing 112. Specifically, the shaft support member 170 is disposed between the compression mechanism 130 and the electric motor 140 so that a part of the shaft support member 170 faces the inner periphery of the first coil ends 162E1 and a first balance weight 156, which will be described in detail later. That is, a part of the shaft support member 170 is disposed inward of the first coil end 162E1 in radial direction of the rotary shaft 163 so as to be surrounded thereby.

The shaft support member 170 has at the center thereof a hole 170H through which the rotary shaft 163 is inserted. The shaft support member 170 and the suction housing 112 cooperate to define therebetween a motor chamber that accommodates therein the electric motor 140.

The suction housing 112 accommodates therein the rotary shaft 163. The rotary shaft 163 is rotatably supported at a first end portion 164E1 thereof that is located in the vicinity of the opening of the suction housing 112 and inserted through the hole 170H of the shaft support member 170 by the shaft support member 170 via a first radial bearing 171. A part of the first radial bearing 171 is disposed inward of the first coil end 162E1 and faces to the first balance weight 156.

The rotary shaft 163 is also rotatably supported at a second end portion 164E2 thereof that is located in the vicinity of a bottom wall 112B of the suction housing 112 by the bottom wall 112B of the suction housing 112 via a second radial bearing 172.

The suction housing 112 has a cylindrical radial bearing support 112S extending from the inner surface of the bottom wall 112B (the surface of the bottom wall 112B that is in the vicinity of the electric motor 140). The radial bearing support 112S is disposed coaxially with the shaft body 164 and the second bearing 172 is supported by the radial bearing support 112S.

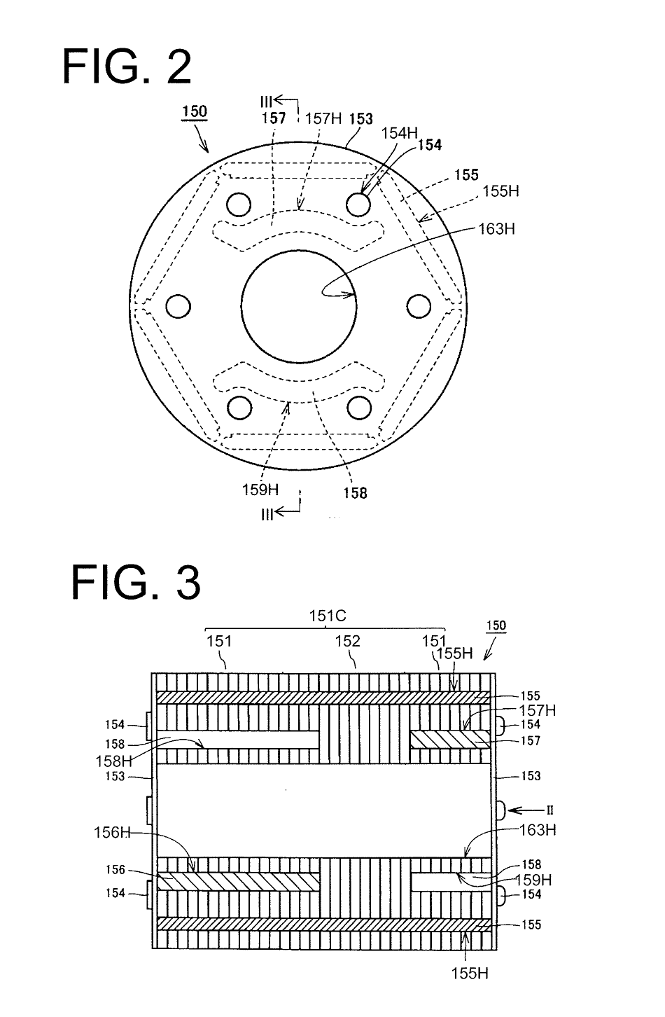

The following will describe the rotor 150 of the electric compressor 100 according to the first embodiment in detail with reference to FIGS. 2 and 3

Referring to FIG. 3, the rotor 150 has a hollow cylindrical shape and includes a hollow cylindrical rotor core 150C, six magnets 155 that are disposed inside the cylindrical rotor core 150C, and the aforementioned first balance weight 156 and a second balance weight 157 that are disposed in the rotor core 150C and made of a non-magnetic material having a greater specific gravity than the material forming the rotor core 150C.

The rotor core 150C of the rotor 150 includes two end plates 153 holding therebetween a plurality of magnetic steel sheets and six rivet pins 154 that integrate the magnetic steel sheets and the end plates 153 together. The rivet pin 154 has a generally cylindrical shape and includes an shank portion that is inserted through the holes formed through the plurality of magnetic steel sheets and a head portion that is formed at one axial end of the rivet pin 154.

The six magnets 155 are disposed in the rotor core 150C extending throughout its entire length of the rotor core 150C. The magnet 155 has a plate shape and is made of a permanent magnet such as a ferrite magnet and a rare earth magnet.

The first balance weight 156 is disposed in the vicinity of the compression mechanism 130 in a direction of the rotation axis of the rotor 150 (left side in FIG. 3), or in the vicinity of a first end of the rotor 150. The second balance weight 157 is disposed in the vicinity of a second end of the rotor 150 (right side in FIG. 3). The first and second balance weights 156, 157 of the present embodiment have a substantially the same shape as seen in cross section perpendicular to the direction of the rotation axis of the rotor core 150C but differ in the dimensions in direction of the rotation axis of the rotor core 150C.

The first and second balance weights 156, 157 are made of a brass in the present embodiment, but any non-magnetic material having a greater specific gravity than the magnetic steel sheets, such as a stainless steel, may be used for the first and second balance weights 156, 157.

The rotor core 150C is formed of a plurality of laminated magnetic steel sheets. Specifically, the laminated magnetic steel sheets of the rotor core 150C of the present embodiment includes the first magnetic steel sheets 151 and the second magnetic steel sheets 152.

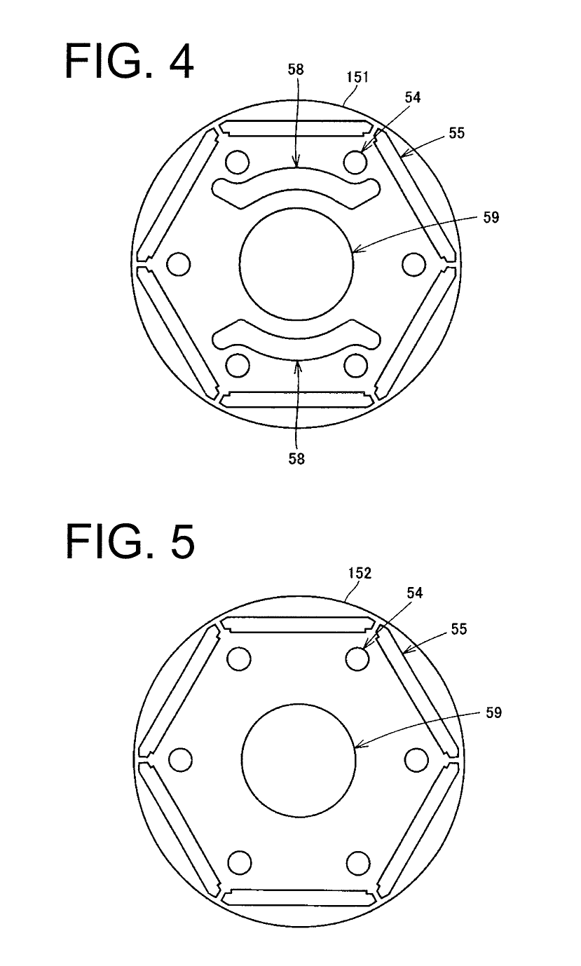

As shown in FIGS. 4 and 5, the first and second magnetic steel sheets 151, 152 have a substantially the same circular shape.

The first and second magnetic steel sheets 151, 152 have therethrough at the center thereof a circular first hole 59, and the center of the contour of the first and second magnetic steel sheets 151, 152 is positioned substantially the same position of the center of the first hole 59. The first hole 59 has a diameter that is slightly smaller than that of the shaft body 164 of the rotary shaft 163.

The first and second magnetic steel sheets 151, 152 have therethrough in the periphery thereof six second holes 55 having generally rectangular shape, respectively. The six second holes 55 of each magnetic steel sheet are arranged in a regular hexagonal shape, or along the sides of an imaginary regular hexagon except the apexes thereof. The six second holes 55 are spaced from each other. The second holes 55 are point symmetric with respect to the center of the first hole 59. The second hole 55 is formed slightly larger than the magnet 155 in cross section.

The first and second magnetic steel sheets 151, 152 have therethrough six circular third holes 54 at positions that are in the vicinity of and radially inward of the apexes of the above imaginary hexagon formed by the second holes 55. The third holes 54 are also point symmetric with respect to the first hole 59. The third hole 54 has a diameter that is slightly greater than that of the shank portion of the rivet pin 154.

The first magnetic steel sheet 151 has therethrough two fourth holes 58 between the first hole 59 and the second hole 55. Although the fourth hole 58 is formed between the first hole 59 and the third holes 54 in the present embodiment, the fourth hole 58 may be formed between the second hole 55 and the third holes 54. The fourth holes 58 are point symmetric with respect to the first hole 59. The fourth hole 58 has a dimension that is slightly greater than the first balance weight 156 and the second balance weight 157 in cross section. The fourth holes 58 have a generally bow shape, and the middle portion of each fourth hole 58 extends along of the circular first hole 59 and the opposite ends of the fourth hole 58 extend along the circular third holes 54. It is noted that no hole such as the fourth hole 58 is formed in the second magnetic steel sheet 152.

In the following description, symbols X, Y and Z will be used to represent the numbers of the first magnetic steel sheets 151, the second magnetic steel sheets 152 and the first magnetic steel sheets 151 laminated into the rotor core 150C. The X first magnetic steel sheets 151, the Y second magnetic steel sheets 152 and the Z first magnetic steel sheets 151 are laminated into the rotor core 150C in this order. The rotor core 151 is disposed in the suction housing 112 so that the X first magnetic steel sheets are disposed in the vicinity of the first end of the rotor 150 the Z first magnetic steel sheets 151 are disposed in the vicinity of the second end of the rotor 150. The number X of the first magnetic steel sheets 151 is greater than the number Z of the first magnetic steel sheets 151.

With the first and second magnetic steel sheets 151, 152 laminated together, the first holes 59 of the first and second magnetic steel sheets 151, 152 are connected thereby to form a first hole portion 163H through which the shaft body 164 of the rotary shaft 163 is inserted. In the present embodiment, the shaft body 164 is fitted to the first hole portion 163H by shrinkage fit. In addition, with the first and second magnetic steel sheets 151, 152 laminated together, the six second holes 55 of the first and second magnetic steel sheets 151, 152 are connected thereby to form six second hole portions 155H in which the six magnets 155 are inserted, respectively. With the first and second magnetic steel sheets 151, 152 laminated together, the six third holes 54 of the first and second magnetic steel sheets 151, 152 are connected thereby to form six insertion holes 154H in which the six rivet pins 154 are inserted, respectively.

In the rotor core 150C, with the X first magnetic steel sheets 151 laminated together, the two fourth holes 58 of the laminated first magnetic steel sheets are connected thereby to form a third hole portion 156H in which the first balance weight 156 is inserted and a fourth hole portion 158H. The fourth hole portion 158H is disposed opposite to the third hole portion 156H in radial direction of the rotor 150 with the first hole portion 163H positioned between the fourth hole portion 158H and the third hole portion 156H. The third hole portion 156H and the fourth hole portion 158H have substantially the same shape as seen in cross section perpendicular to the direction of the rotation axis of the rotor core 150C of the rotor 150 and are arranged between the first hole portion 163H and the second hole portion 155H.

With the Z fourth holes 58 of the laminated together, the two fourth holes 58 of the laminated first magnetic steel sheets 151 are connected thereby to form a third hole portion 157 H in which the second balance weight 157 is inserted and a fourth hole portion 159H. The fourth hole portion 159H is disposed opposite to the third hole portion 157H in radial direction of the rotor 150 with the first hole portion 163H positioned between the fourth hole portion 159H and the third hole portion 157H. The third hole portion 157H and the fourth hole portion 159H have a substantially the same shape as seen in cross section perpendicular to the direction of the rotation axis of the rotor core 150C of the rotor 150 and are arranged between the first hole portion 163H and the second hole portion 155H. In addition, the fourth portion 158H is formed larger than the fourth portion 159H.

The third hole portion 156H of the rotor core 150C that is disposed in the vicinity of the first end of the rotor 150 has therein the first balance weight 156, and the third hole portion 157H of the rotor core 150C that is disposed in the vicinity of the second end of the rotor 150 has therein by the second balance weight 157.

Although the first balance weight 156 and the second balance weight 157 are both made of a brass and have a substantially the same shape in cross section, the first balance weight 156 is longer than the second balance weight 157 in direction of the rotation axis of the rotor 150, so that the first balance weight 156 has a weight that is heavier than the second balance weight 157.

The first balance weight 156 is entirely disposed in the third hole portion 156H that is formed at a position that is in the vicinity of the first end of the rotor 150, or first coil end 162E1 (left side in FIG. 3). Additionally, the first balance weight 156 is disposed opposite to the eccentric pin 165 in radial direction of the rotary shaft 163. Although the first balance weight 156 is entirely disposed in the third hole portion 156H in the present embodiment, it may be so configured that the first balance weight 156 may be disposed in the third hole portion 156H partially.

The second balance weight 157 is entirely disposed in the third hole portion 157H that is formed at a position that is in the vicinity of the second end of the rotor 150, or second coil end 162E2 (right side in FIG. 3). Additionally, the second balance weight 157 is disposed opposite to the first balance weight 156 in radial direction of the rotary shaft 163. Although the second balance weight 157 is entirely disposed in the third hole portion 157H in the present embodiment, it may be so configured that the second balance weight 157 is disposed in the third hole portion 157H partially.

As has been described, the first balance weight 156 and the second balance weight 157 are disposed opposite to each other in radial direction of the rotor 150, that is, point symmetric with respect to the rotation axis of the rotor 150.

The fourth hole portion 158H that is formed in the vicinity of the first end of the rotor 150 is larger than the fourth hole portion 159H that is formed in the vicinity of the second end of the rotor 150.

In other words, the fourth hole portion 158H having a larger volume is disposed in the vicinity of the first end of the rotor 150 and at a position radially corresponding to the eccentric pin 165 of the rotary shaft 163 in radial direction of the rotor 150, and the fourth hole portion 159H having a smaller volume is disposed in the vicinity of the second end of the rotor 150 at a position that is opposite to the eccentric pin 165 of the rotary shaft 163 in radial direction of the rotor 150.

The fourth hole portion 158H having a large volume and the fourth hole portion 159H having a small volume are disposed in the rotor core 150C at positions that are radially and axially opposite to each other, or point symmetric relation to each other with respect to the axis of the rotor 150. In addition, the fourth hole portion 158H having larger volume 158 and the first balance weight 156 are disposed in the rotor core 150C at positions that are radial opposite to each other, or point symmetric relation to each other and the fourth hole portion 159H having a smaller volume and the second balance weight 157 are also disposed point symmetric relation to each other with respect to and imaginary plane extending horizontally through the axis of the rotor 150 in FIG. 2.

In the above described configuration of the rotor 150, the first balance weight 156 and the fourth hole portion 158H having a large volume create a relatively large weight imbalance in the part of the rotor 150 in the vicinity of the first end of the rotor 150 and the second balance weight 157 and the fourth hole portion 159H having a small volume 158 create a relatively small weight imbalance in the part of the rotor 150 in the vicinity of the second end of the rotor 150.

The weight imbalance in the first end and the second end of the rotor 150 is oppositely arranged.

The following will describe the operation of the electric compressor 100. The rotary shaft 163 of the electric motor 140 of the electric compressor 100 is driven to rotate at a controlled speed by the electric power that is controlled and supplied by the inverter 180. Thus, the movable scroll 135 makes an orbital movement about the axis of the fixed scroll 131 by way of the eccentric pin 165 thereby to compress a refrigerant gas in the compression chamber defined between the movable scroll 135 and the fixed scroll 131. The centrifugal force to the movable scroll 135 is balanced by the first balance weight 156, the second balance weight 157, the empty portions 158 and the weight 139 of the bush 138.

The electric compressor 100 of the present embodiment offers following effects.

(1) The rotor core 150C is provided with the first balance weight 156 and the second balance weight 157, and the first balance weight 156 is disposed in the third hole portion 156H that is disposed in the vicinity of the first end of the rotor 150. Part of the shaft support member 170 is arranged so as to face the inner periphery of the first coil end 162E1 and the first balance weight 156. Such configuration permits the shaft support member 170 to be positioned close to the rotor core 150C while the electric compressor 100 is effectively balanced during the orbital movement of the movable scroll 135, with the result that to the axial dimension of the electric compressor 100 may be reduced.
(2) The electric compressor 100 is balanced appropriately by the first balance weight 156, the second balance weight 157 and the bush 138 having the weight 139 during the orbital movement of the movable scroll 135, with the result that the first balance weight 156 and the second balance weight 157 may be downsized.
(3) According to the embodiment, the first balance weight 156 has a weight that is greater than that of the second balance weight 157. Compared with the case in which the second balance weight 157 has a weight that is greater than the first balance weight 156, the present embodiment is advantageous in downsizing the first and second balance weight 156, 157.
(4) The fourth hole portion 159H is disposed opposite to the third hole portion 157 H in radial direction of the rotor 150 with the first hole portion 163H positioned between the fourth hole portion 159H and the third hole portion 157H. The fourth hole portion 158H is disposed opposite to the third hole portion 156H in radial direction of the rotor 150 with the first hole portion 163 positioned between the fourth hole portion 158H and the third hole portion 156H. Accordingly, the weight imbalance in the rotor 150 in radial direction thereof is easily produced.
(5) The third hole portions 156H, 157H have substantially the same shape as the fourth hole portions 158H, 159H as seen in cross section perpendicular to the rotation axis of the rotor 150. This configuration is advantageous in the lamination of the first magnetic steel sheets 151 because the two fourth holes 58 of the first magnetic steel sheet 151 are formed symmetric to each other with respect to an imaginary line extending horizontally through the center of first magnetic steel sheet 151 as seen in FIG. 2 and the first magnetic steel sheet 151 may be positioned upside down as seen in FIG. 2 in laminating the first magnetic steel sheets 151.
(6) The entire second balance weight 157 is inserted in the third hole portion 157H. This prevents the interference between the second balance weight 157 and the cluster block 190.
(7) The arrangement of the plurality of the third hole portions 156H, 157H and the plurality of the fourth hole portions 158H, 159H between the first hole portion 163H and the plurality of the second hole portions 155H permits a relatively large balance weight to be used in the rotor 150 without reducing the motor torque. Although the weight of the first balance weight 156 and the second balance weight 157 of the present embodiment are made different by altering the dimension thereof in axial direction of the rotor 150, the weight of the balance weights may be made different by using different shapes or different materials.

The rotor 150 of the present embodiment may be modified in various manners, such as in the arrangement, the number and the shape of the respective rotor parts. For example, the rotor 150 may have therein three or more balance weights having different weights. In this case, the balance weights should preferably be arranged in such a manner that the weight of the balance weights is increased toward the compression mechanism 130 (or left side in FIG. 3). In other words, the balance weight disposed in the vicinicy of the first end of the rotor 150 is heavier than the balance weight disposed in the vicinity of the second end of the rotor 150.

In addition, the rotor 150 may have therein three or more fourth hole portions having different volumes. In this case, the fourth hole portions should preferably be arranged in such a manner that the volume of the fourth hole portion that is disposed in the vicinity of the first end of the rotor 150 is greater than the volume of the fourth hole portion disposed closer to the second end of the rotor 150. In other words, the fourth hole portions are disposed so that the volumes of the fourth hole portions are increased toward the compression mechanism 130 (or left side in FIG. 3).

The compression mechanism 130 may be configured in any way as long as it includes a movable member mounted on a pin that is disposed eccentric to the rotation axis of the shaft body of the rotary shaft.

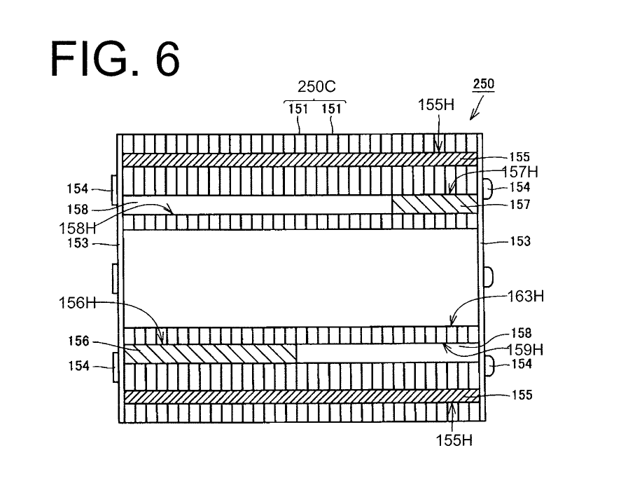

The following will describe a second embodiment of the present invention with reference to FIG. 6. The electric compressor 100 of the second embodiment differs in the rotor structure from the first embodiment. For the sake of the description, like or same parts or elements of the different embodiments are designated by the same reference numerals and the description thereof will not be reiterated.

FIG. 6 is similar to the cross-sectional view of FIG. 3, but showing a rotor of the electric compressor 100 according to the second embodiment.

As shown in FIG. 6, the electric compressor 100 of the second embodiment is provided with a rotor 250 that includes a hollow cylindrical rotor core 250C, six magnets 155 that are disposed in the rotor core 250C, a first balance weight 156 and a second balance weight 157 that are made of a non-magnetic material having greater specific gravity than the material forming the rotor core 250C.

The rotor 250 further includes two end plates 153 to hold therebetween a plurality of magnetic steel sheets and six rivet pins 154 that fasten the magnetic steel sheets held between the end plates 153 together.

The rotor core 250C is formed by laminating the first magnetic steel sheets 151. In other words, the rotor core 250C is formed only by the first magnetic steel sheets 151 and includes no second magnetic steel sheet such as 152 in the first embodiment.

In the rotor core 250C, with the first and second magnetic steel sheets 151 laminated together, the two fourth holes 58 of the plurality of the first magnetic steel sheets 151 are connected thereby to form the third hole portions 156H, 157H in which the first and second balance weight 156, 157 and the fourth hole portions 158H, 159H.

The first balance weight 156 is inserted in the third hole portion 156H that is disposed in the vicinity of the compression mechanism 130 in a direction of the rotation axis of the rotor 250 (left side in FIG. 6), or in the vicinity of the first end of the rotor 250, and the second balance weight 157 is inserted in the third hole portion 157H that is in the vicinity of the second end of the rotor 250 in the direction of the rotation axis of the rotor 250 (right side in FIG. 6). The first balance weight 156 and the second balance weight 157 are fitted in their corresponding third hole portions 156H, 157H, respectively.

The fourth hole portion 158H that is formed in the vicinity of the first end of the rotor 250 (left side in FIG. 6) has a volume that is larger than the fourth hole portion 159H that is formed in the vicinity of the second end of the rotor core 250C (right side in FIG. 6).

In other words, the fourth hole portions 158H having a large volume is disposed at a position that is in the vicinity of the first end the rotor 250 and corresponds to the eccentric pin 165 of the rotary shaft 163 in radial direction of the rotor 250 (upper side in FIG. 6). The fourth hole portion 159H having a small volume is disposed at a position that is in the vicinity of the second end of the rotor 250 that is opposite to the eccentric pin 165 of the rotary shaft 163 in radial direction thereof (lower side in FIG. 6). In other words, the fourth hole portion 158H having a large volume and the fourth hole portion 159H having a smaller volume are disposed point symmetric relation to each other with respect to the axis of the rotor 250.

In the second embodiment, the fourth hole portion 159H having a smaller volume and the third hole portion 156H are formed by a common hole. The fourth hole portion 158H having a larger volume and the third hole portion 157H are also formed by a common hole.

The first and second balance weights 156, 157 are fitted in their corresponding third hole portions 156H, 157H, so that the first and the second balance weights 156, 157 are held in the rotor 250 without moving even if the third hole portions 156H, 157H are not closed by the second magnetic steel sheets 152 as in the case of the first embodiment.

The first and second balance weights 156, 157 need not be held by being fitted in their corresponding third hole portions 156H, 157H but may be fixed in the third hole portions 156H, 157H by using adhesive.

In the above described configuration of the rotor 250, the first balance weight 156 and the fourth hole portion 158H having a larger volume create a relatively large weight imbalance in the rotor 250 in the vicinity of the first end of the rotor 250 and the second balance weight 157 and the fourth hole portion 159H having a smaller volume create a relatively small weight imbalance in the rotor 250 in the vicinity of the second end of the rotor 250.

The weight imbalance in the first end and the second end of the rotor 250 is oppositely arranged.

The above-described second embodiment of the present invention offers the effect below, as well as the effects (1) to (7) described with reference to the first embodiment.

(8) The number of parts of the rotor 250 may be reduced because the rotor core 250C uses only the first magnetic steel sheet 151. Additionally, the weight of the electric compressor may be reduced because the rotor 250 of the second embodiment has a larger empty space, as compared to the rotor 150 of the first embodiment.

According to the present invention, the compressor of the above first and second embodiments maybe modified in various manners, as exemplified below.

The fourth hole portions 158H, 159H need not be formed in the rotor core 250C.

The movable scroll 135 may be supported by the eccentric pin 165 via an eccentric pin bearing without using the bush 138.

The above embodiments have been described to show an example of the present invention and are not intended to limit the scope of the invention. The scope of the present invention is defined in appended claims and intended to include equivalents and all changes and modification that fall within the scope of the present invention.

What is claimed is:

1. An electric compressor comprising:
a compression mechanism having a movable member and compressing fluid;
an electric motor having a rotary shaft and driving the compression mechanism;
a shaft support member disposed between the compression mechanism and the electric motor and rotatably supporting the rotary shaft; and
a housing accommodating therein the compression mechanism, the electric motor and the shaft support member,
wherein the rotary shaft includes a shaft body and an eccentric pin extending from one end of the shaft body at a position that is eccentric to a rotation axis of the shaft body, wherein the eccentric pin supports the movable member,
wherein the electric motor includes a stator that includes a stator core fixed to the housing and a coil that is wound around the stator core, and a hollow cylindrical rotor that is fixed on the shaft body of the rotary shaft,
wherein the coil has a first coil end and a second coil end that extend out from opposite ends of the stator core in a direction of the rotation axis of the shaft body,
wherein the first coil end is arranged between the stator core and the compression mechanism,
wherein the rotor includes a cylindrical rotor core, a plurality of magnets that are disposed inside the rotor core, and a plurality of balance weights that are made of a non-magnetic material having a greater specific gravity than a material forming the rotor core, wherein the balance weights are disposed in the rotor core,
wherein the rotor core includes a first hole portion through which the rotary shaft is inserted, a plurality of second hole portions in which the respective magnets are inserted, and a plurality of third hole portions in which the respective balance weights are inserted,
wherein the balance weights include a first balance weight that is disposed in the vicinity of the first coil end in a direction of a rotation axis of the rotor core, wherein at least part of the first balance weight is inserted in one of the third hole portions, and
wherein at least part of the shaft support member faces an inner periphery of the first coil end and the first balance weight.

2. The electric compressor according to claim 1, wherein the balance weights include a second balance weight that is disposed in the vicinity of the second coil end in the direction of the rotation axis of the rotor core, wherein the first balance weight is heavier than the second balance weight.

3. The electric compressor according to claim 1, wherein the rotor core has a plurality of fourth hole portions, and wherein the fourth hole portions are disposed opposite to the third hole portions with respect to the first hole portion in radial direction of the rotary shaft.

4. The electric compressor according to claim 3, wherein the fourth hole portions formed in the vicinity of the first coil end in the direction of the rotation axis of the rotor core is larger than the fourth hole portions formed in the vicinity of the second coil end in the direction of the rotation axis of the rotor core.

5. The electric compressor according to claim 3, wherein the third hole portions and the fourth hole portions are disposed between the first hole portion and the second hole portions.

6. The electric compressor according to claim 3, wherein the third hole portions and the fourth hole portions have the same shape as seen in any cross section perpendicular to the direction of the rotation axis of the rotor core.

7. The electric compressor according to claim 1, wherein a bush having a weight is fitted on the eccentric pin.
